(19) United States
(12) Patent Application Publication
(10) Pub. No.: US 2018/0018388 A1
(43) Pub. Date: Jan. 18, 2018

(54) METHODS AND SYSTEMS FOR EFFICIENT QUERYING OF TIME-SERIES DATABASES

(71) Applicant: Julian Mulla, Chicago, IL (US)

(72) Inventor: Julian Mulla, Chicago, IL (US)

(21) Appl. No.: 15/650,615

(22) Filed: Jul. 14, 2017

Related U.S. Application Data
(60) Provisional application No. 62/363,670, filed on Jul. 18, 2016.

(51) Int. Cl. G06F 17/30; G06F 17/27; G06F 17/10

(52) U.S. Cl. CPC G06F 17/30672; G06F 17/30504; G06F 17/3005; G06F 17/2705; G06F 17/10

(57) ABSTRACT

Disclosed herein are methods and systems for efficient querying of time-series databases. An embodiment takes the form of a method that includes receiving a query-input string that includes delimited character strings. The method includes generating, based on the query-input string, a query structure that includes one or more phrases. The character strings specify one or more segments of one or more clauses of one or more of the phrases. The query-input string is parsed to identify the one or more specified segments that are then added to the corresponding one or more phrases of the query structure. The method includes submitting the query structure to a query-processing system for use in querying a time-series database, receiving a query result set that was obtained from the time-series database as responsive to the query structure, and outputting the query result set for presentation via a user interface.

### CROSS-REFERENCE TO RELATED APPLICATIONS

This application claims the benefit of U.S. Provisional Patent Application No. 62/363,670, filed Jul. 18, 2016, entitled “Methods and Systems for Efficient Querying of Time-Series Databases,” which is hereby incorporated herein by reference in its entirety.

### BACKGROUND OF THE INVENTION

Tools that aid in the analysis of data stored within time-series databases are of interest in both the academics and business. In the context of financial data, academics use past prices, volumes, and economic data to test research hypotheses. In business, industry professionals use this financial data as a basis for trading decisions. However, one obstacle to their analysis is the time-series nature of the data. Traditional relational, columnar, and graph data models all have difficulty with order-dependent, time-series data. Extracting information requires linking rows or nodes using complex and computationally-expensive SQL joins.

Previous attempts to efficiently search time-series data, particularly financial time-series data, are not fit-for-purpose. Many of these attempts incorporate proprietary or SQL-extension syntaxes. Further, these attempts to search time-series data may not be sufficiently expressive to articulate research hypotheses or trading strategies in an intuitive way. Often, a professional computer programmer is required to retrieve the requested financial data from the time-series database.

Other attempts to efficiently search time-series data include visual query systems. However, in visual query systems, as functionality is added, the boxes and lines of the visual query can become more complex than text-based code and become more difficult to debug. In many other cases, vendor technologies do not facilitate replication or cross-platform integration for implementation of research results and ad hoc technologies are developed to assist in analyzing the data.

Accordingly, there is a need for methods and systems for efficient querying of time-series databases.

### BRIEF DESCRIPTION OF THE SEVERAL VIEWS OF THE DRAWINGS

A more detailed understanding may be had from the detailed description below, which is presented by way of example in conjunction with the following drawings, in which like reference numerals are used across the drawings in connection with like elements.

FIG. 1 depicts a method of querying time-series databases, in accordance with at least one embodiment.

FIG. 2 depicts a first example query structure, in accordance with at least one embodiment.

FIG. 3A depicts a first functional block diagram, in accordance with an embodiment.

FIG. 3B depicts a second functional block diagram, in accordance with an embodiment.

FIG. 4A depicts a second example query structure, in accordance with at least one embodiment.

FIG. 4B depicts a third example query structure, in accordance with at least one embodiment.

FIG. 5 depicts variations of a buy-sell phrase, in accordance with at least one embodiment.

FIG. 6A depicts variations of a timeframe phrase, in accordance with at least one embodiment.

FIG. 6B depicts variations of a market phrase, in accordance with at least one embodiment.

FIG. 7A depicts variations of a conditions phrase, in accordance with at least one embodiment.

FIG. 7B depicts variations of a conditions clause, in accordance with at least one embodiment.

FIG. 7C depicts variations of a general indicator form, in accordance with at least one embodiment.

FIG. 7D depicts variations of a binary operator, in accordance with at least one embodiment.

FIG. 7E depicts variations of a unary operator, in accordance with at least one embodiment.

FIG. 7F depicts variations of an indicator with parentheses, in accordance with at least one embodiment.

FIG. 7G depicts variations of an indicator without parentheses, in accordance with at least one embodiment.

FIG. 7H depicts variations of an expression clause, in accordance with at least one embodiment.

FIG. 7I depicts variations of a term clause, in accordance with at least one embodiment.

FIG. 7J depicts variations of a factor clause, in accordance with at least one embodiment.

FIG. 8 depicts variations of an operator qualifier, in accordance with at least one embodiment.

FIG. 9A depicts variations of a money-management phrase, in accordance with at least one embodiment.

FIG. 9B depicts variations of a stop clause, in accordance with at least one embodiment.

FIG. 9C depicts variations of an objective clause, in accordance with at least one embodiment.

FIG. 9D depicts variations of a horizon clause, in accordance with at least one embodiment.

FIG. 10 depicts a presentation of a query-response set, in accordance with at least one embodiment.

FIG. 11 illustrates an exemplary wireless transmit/receive unit (WTRU), in accordance with at least one embodiment.

FIG. 12 illustrates an exemplary network entity, in accordance with at least one embodiment.

Before proceeding with the detailed description, it is noted that the entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—can only properly be read as being constructively preceded by a clause such as “In at least one embodiment . . . .” And it is for reasons akin to brevity and clarity of presentation that this implied leading clause is not repeated ad nauseum in the below detailed description of the drawings.

### DETAILED DESCRIPTION

One embodiment takes the form of a method that includes receiving a query-input string for querying a time-series database. The query-input string includes a sequence of delimited character strings. The method also includes generating a query structure based on the query-input string. The query structure includes a plurality of phrases that each include one or more clauses that each include one or more segments. The character strings specify one or more of the segments of one or more of the clauses of one or more of the phrases. Generating the query structure based on the query-input string includes parsing the query-input string to identify the one or more specified segments, and also includes adding the one or more specified segments to the corresponding one or more phrases of the query structure. The method also includes submitting the query structure to a query-processing system for use in querying the time-series database, receiving a query result set that was obtained from the time-series database as being responsive to the submitted query structure, and outputting the received query result set for presentation via a user interface.

Another embodiment takes the form of a system that includes a communication interface, a processor, and data storage containing instructions executable by the processor for carrying out at least the functions described in the preceding paragraph.

Moreover, any of the variations and permutations described herein can be implemented with respect to any embodiments, including with respect to any method embodiments and with respect to any system embodiments. Furthermore, this flexibility and cross-applicability of embodiments is present in spite of the use of slightly different language (e.g., process, method, steps, functions, set of functions, and the like) to describe and or characterize such embodiments.

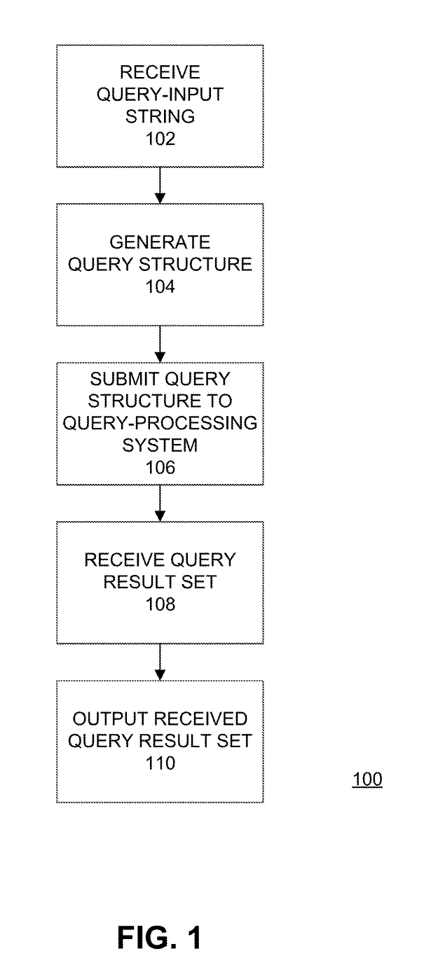

FIG. 1 depicts a method for efficient querying of time-series databases, in accordance with an embodiment. In particular, FIG. 1 depicts the method 100. The method 100 includes receiving a query-input string at 102, generating a query structure at 104, submitting the query structure to a query-processing system at 106, receiving a query result set at 108, and outputting the received query result set at 110.

At 102, the received query-input string is for querying a time-series database, wherein the query input string comprises a sequence of delimited character strings. In some embodiments, the query-input string is entered via a user interface, is received via the user interface, or received via a network connection.

The time-series database may be a financial-information, a sports-information, a weather-information, a vehicle-traffic-information, data-traffic information, a polling-information, or a political-polling-information time-series database.

At 104, a query structure, based on the query-input string, is generated. The query structure comprises a plurality of phrases that each comprise one or more clauses that each comprise one or more segments. The character strings specify one or more of the segments of one or more of the clauses of one or more of the phrases. Generating the query structure in 104 based on the query-input string comprises parsing the query-input string to identify the one or more specified segments and adding the one or more specified segments to the corresponding one or more phrases of the query structure. In some embodiments, parsing the query-input string comprises parsing the query-input string in a case-insensitive manner.

At 106, the query structure is submitted to a query-processing system for use in querying the time-series database. At 108, a query result set, obtained from the time-series database as being responsive to the submitted query structure, is received. At 110, the received query result set is output for presentation via the user interface.

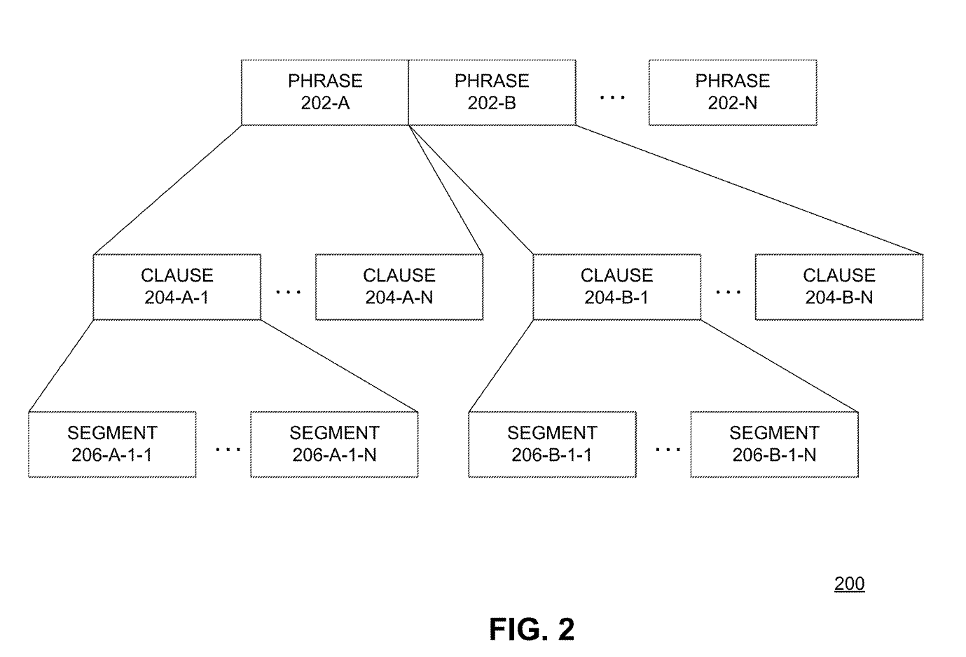

FIG. 2 depicts a first example query structure, in accordance with an embodiment. In particular, FIG. 2 depicts the first example query structure 200. The query structure 200 includes a plurality of phrases (202-A, 202-B, and 202-N), clauses (204-A-1, 204-A-N, 204-B-1, and 204-B-N), and segments (206-A-1-1, 206-A-1-N, 206-B-1-1, and 206-B-1-N). In the query structure 200, the “N” indicates any number of phrases, clauses, or segments may be included in the query structure.

In FIG. 2, the query structure 200 includes a plurality of phrases that each comprise one or more clauses that each comprise one or more terms. For example, the phrases 202-A comprises the clauses 204-A-1 to 202-A-N, and the clause 204-A-1 comprises the segments 206-A-1-1 and 206-A-1-N. One or more of the segments in the query structure 200 are specified by delimited character strings from the received query-input string. In some embodiments, the delimited character strings are whitespace-delimited character strings. Additionally, generating the query structure 200 may include completing phrases in the plurality of phrases using one or both of at least one predetermined default segment and at least one predetermined default clause.

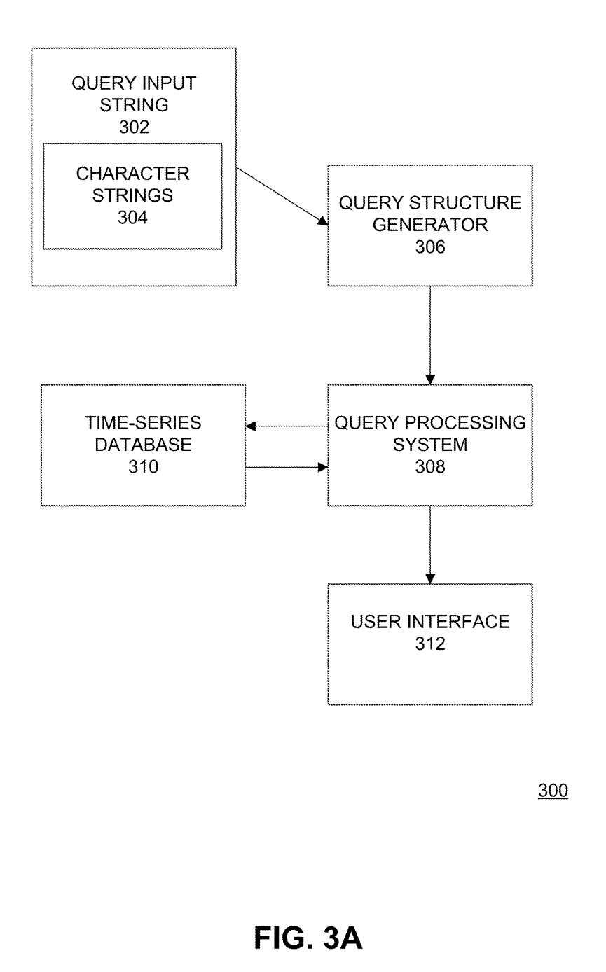

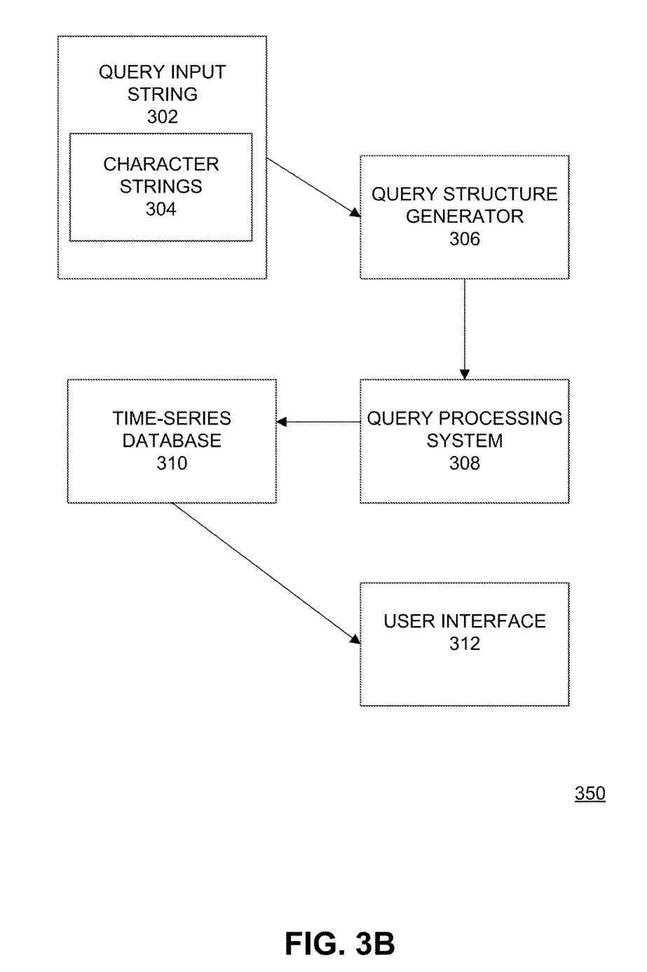

FIG. 3A depicts a first functional block diagram, in accordance with an embodiment. In particular, FIG. 3A depicts the functional block diagram 300. The functional block diagram 300 includes a query input string 302 having a sequence of delimited character strings 304, a query structure generator 306, a query processing system 308, a time-series database 310, and a user interface 312.

The query input string 302 comprises the sequence delimited of character strings 304. The query structure generator 306 generates a query structure based on the received query input string 302, and delivers the query structure to the query processing system 308. The time-series database 310 is queried using the query structure generated by the query structure generator 306. A query result set, obtained from the time-series database 310 as being responsive to the submitted query structure, is received and outputted for presentation via the user interface 312. In such an embodiment, the query result set is received from the query-processing system 308.

FIG. 3B depicts a second functional block diagram, in accordance with an embodiment. In particular, FIG. 3B depicts the functional block diagram 350. The functional block diagram 350 depicts the same components of the functional block diagram 300 of FIG. 3A. However, FIG. 3A depicts an embodiment wherein receiving the query result set comprises receiving the query result set from the time-series database. In such an embodiment, the query-processing system may receive routing instructions for use by the time-series database in returning the query set. The routing instructions may indicate a location to output the query result set to, such as the user-interface 312.

In some embodiments, the query result set further includes at least one pointer to extract additional information from the time-series database. In one such an embodiment, the query result set may include daily interval data and the pointer indicates additional information, such as hourly or by-trade interval data from the time-series database.

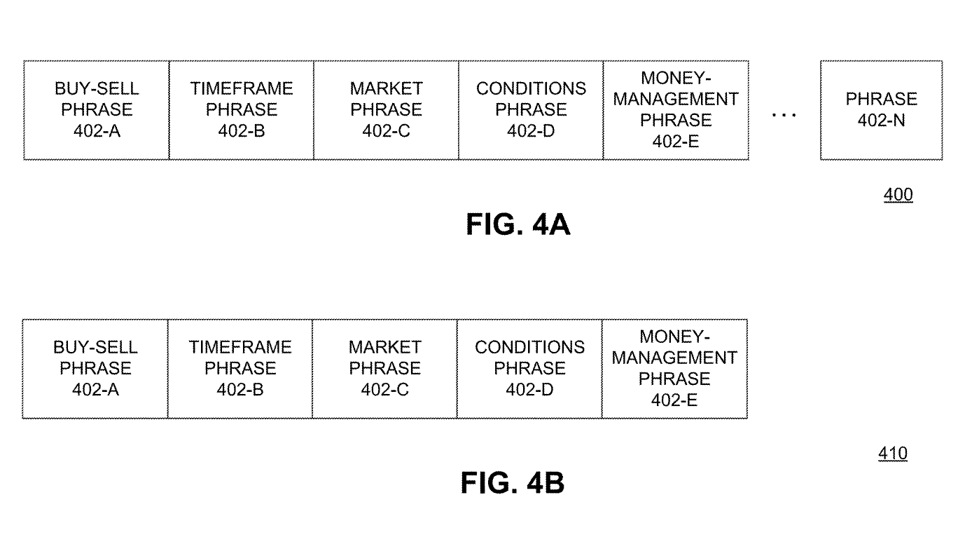

FIG. 4A depicts a second example query structure, in accordance with an embodiment. In particular, FIG. 4A depicts the example query structure 400. The example query structure 400 includes a buy-sell phrase 402-A, a timeframe phrase 402-B, a market phrase 402-C, a conditions phrase 402-D, a money-management phrase 402-E, and phrase 402-N.

The query structure 400 is similar to the query structure 200. Each of the phrases of the query structure 400 include one or more clauses that each comprise one or more segments. In some embodiments, the buy-sell phrase 402-A is before the timeframe phrase 402-B, the timeframe phrase 402-B is before the market phrase 402-C, the market phrase 402-C is before the conditions phrase 402-D, and the conditions phrases 402-D is before the money-management phrase 402-E. Alternatively, the phrases 402A-N may also be arranged in a different order.

FIG. 4B depicts a third example query structure, in accordance with an embodiment. In particular, FIG. 4B depicts the example query structure 410 that includes the buy-sell phrase 402-A, the timeframe phrase 402-B, the market phrase 402-C, the conditions phrase 402-D, and the money-management phrase 402-E. In some embodiments, the plurality of phrases consists of only the buy-sell phrase 402-A, the timeframe phrase 402-B, the market phrase 402-C, the conditions phrase 402-D, and the money-management phrase 402-E. In some such embodiments, the buy-sell phrase 402-A is before the timeframe phrase 402-B, the timeframe phrase 402-B is before the market phrase 402-C, the market phrase 402-C is before the conditions phrase 402-D, and the conditions phrases 402-D is before the money-management phrase 402-E. Alternatively, the phrases 402A-E may also be arranged in a different order than depicted in FIG. 4B.

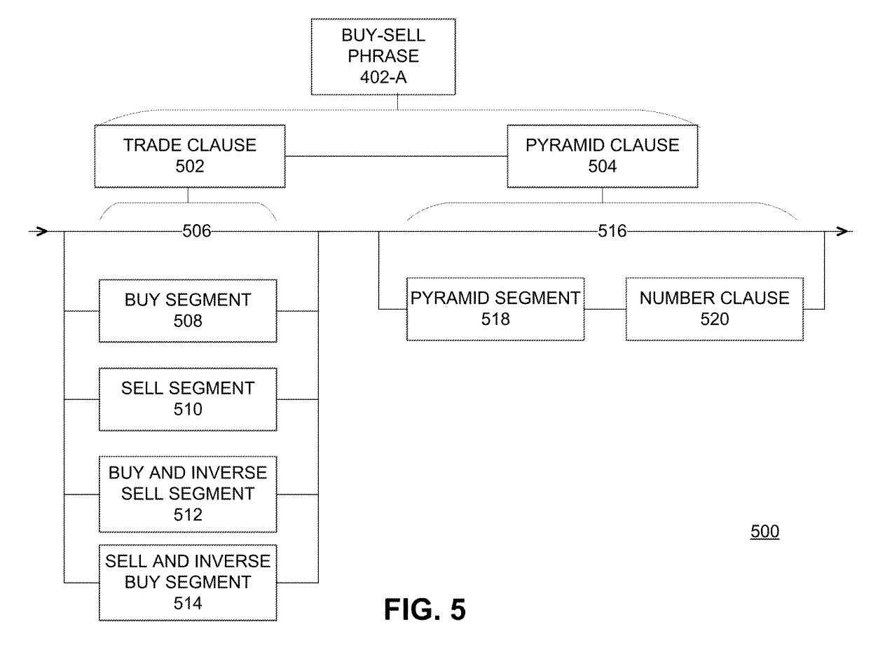

FIG. 5. depicts variations of the buy-sell phrase, in accordance with an embodiment. In particular, FIG. 5 depicts the variations 500 of the buy-sell phrase 402-A. The variations 500 includes the buy-sell phrase 402-A, a trade clause 502, a pyramid clause 504, a null segment 506, a “buy” segment 508, a “sell” segment 510, a “buy and inverse sell” segment 512, a “sell and inverse buy” segment 514, a null segment 516, a “pyramid” segment 518, and a number clause 520. The buy-sell phrase 402-A includes the trade clause 502 and the pyramid clause 504. In generating the buy-sell phrase portion of the query structure, the buy-sell phrase 402A may include both the trade clause 502 and the pyramid clause 504. The trade clause 502 may be filled with one of the segments depicted under the trade clause 502, to include the null segment 506, the “buy” segment 508, the “sell” segment 510, the “buy and inverse sell” segment 512, or the “sell and inverse buy” segment 514.

In the depicted embodiments, the clauses and segments are assembled in the direction of the arrows. As depicted in FIG. 5, the buy-sell phrase 402-A is generated from left to right. This convention is used throughout.

The pyramid clause 504 may be filled with one of the segments depicted under the pyramid clause 504, to include the null segment 516, or the “pyramid” segment 518 followed by the number clause 520. The number clause 520 may include a segment represented by any integer number zero and above. The pyramid clause 518 may be represented by the “pyramid” segment 518 followed by the number clause 520. In some embodiments, the pyramid clause 518 is used to query for an overlapping rolling sample. The pyramid clause 504 is a position builder specifier that includes opening or selling additional positions at a subsequent time period provided that predetermined conditions are satisfied. One example of a pyramid position building specifier includes adding an additional position of a stock each day while the price of the stock is increasing, until the price of the stock stops increasing.

In one embodiment, the buy-sell phrase includes a trade clause, such as the trade clause 502, and the query-input string does not specify a trade clause for the buy-sell phrase. In such an embodiment, completing the phrases (such as the buy-sell phrase 402-A) in the plurality of phrases of the query structure comprises setting the trade clause 502 of the buy-sell phrase 402-A of the query structure equal to a default trade clause. In one embodiment, the default trade clause is selected from any of the segments depicted under the trade clause 502 in FIG. 5. In another such embodiment, the default trade clause is a “buy” trade clause that includes the “buy” segment 508.

The variations 500 depict different compositions of the buy-sell phrase 402-A. For example, the buy-sell phrase 402-A may consist only of the trade clause 502 and not the pyramid clause 504. Alternatively, the buy-sell phrase 402-A may comprise both the trade clause 502 and the pyramid clause 504 in any order. Thus, the buy-sell phrase 402-A may comprise a “buy” trade clause wherein the segment in the trade clause 502 is the “buy” segment 508, a “sell” trade clause wherein the segment in the segment in the trade clause 502 is the “sell” segment 510, a “buy and inverse sell” trade clause wherein the segment in the trade clause 502 is the “buy and inverse sell” segment 512, or a “sell and inverse buy” trade clause wherein the segment in the trade clause 502 is the “sell and inverse buy” segment 514. In some embodiments, the trade clause is a rolling trade clause or an inverse trade clause.

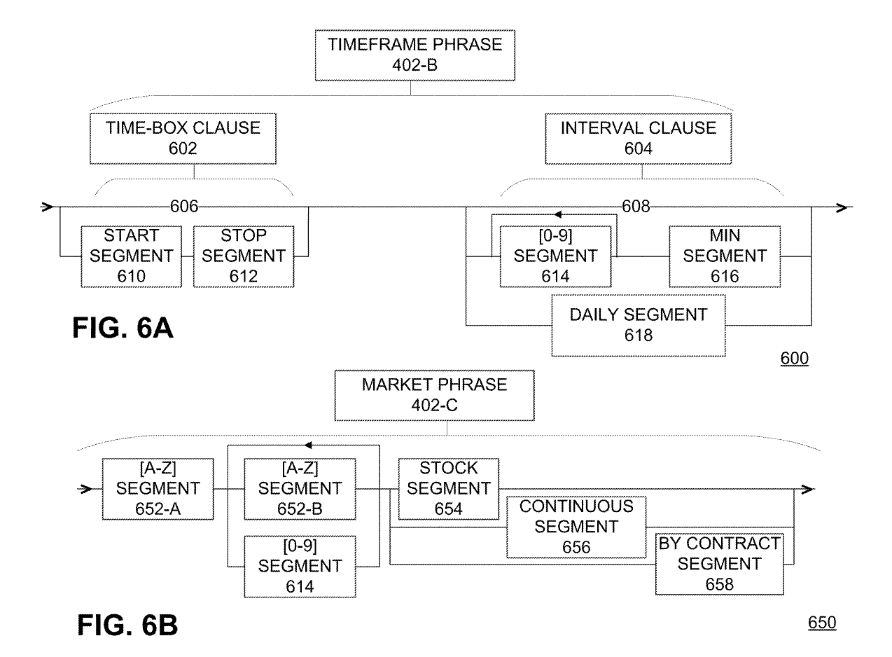

FIG. 6A depicts variations of the timeframe phrase, in accordance with an embodiment. In particular, FIG. 6A depicts the variations 600 of the timeframe phrase 402-B. The variations 600 includes the timeframe phrase 402-B, a time-box clause 602, an interval clause 604, a null segment 606, a “start” segment 610, a “stop” segment 612, a null segment 608, a [0-9] segment 614, a “min” segment 616, and a “daily” segment 618. Time timeframe phrase 402-B may include only the time-box clause 602, only the interval clause 604, both the time-box clause 602 and the interval clause 604, or any number of other clauses.

In embodiments that include the time-box clause 602, the time-box clause has either the null segment 606 or both the “start” segment 610 and the “stop” segment 612. The “start” segment 610 is set to the starting date of the least recent history of data. The “stop” segment 612 is set to the ending date of the most recent history of data. In the context of financial data, the “start” segment 610 is the starting date of the price input data source and the “stop” segment 612 is the end date of the price input data. In an embodiment, the query-input string does not specific a time-box clause for the timeframe phrase, and completing the phrases in the plurality of phrases of the query structure includes setting the time-box clause, such as the time-box clause 602 equal to a default time box. The default time box specifies a least recent data of the time-series database through a most recent date of the timer-series database. The time-box clause 602 may further include additional segments to define the start and stop criteria.

In embodiments that include the interval clause 604, the interval clause has either the null segment 608, the [0-9] segment 614 and the “min” segment 616, or the “daily” segment 618. Similar to other null segments of the disclosure, the null segment 608 is a blank segment. The [0-9] segment 614 is similar to the number clause 520 and may include any integer 0 and above. The [0-9] segment 614 is followed by a time period, and in this embodiment, the time period is selected as minutes with the “min” segment 616, although another unit of time, such as seconds, minutes, hours, days, weeks, months, or years, may also be selected. In another embodiment, the interval clause includes the “daily” segment 618, indicating that daily data is requested and corresponds a single daily piece of data, such as the open price, close price, high price, low price, average price, or the like.

In some embodiments, the interval clause 604 defines a period in segments other than time. Such examples include a number of contracts executed, a number of shares traded, or the like. The interval clause 604 may then include an activity-interval clause. The activity-interval clause includes segments to define a bar interval based at least in part on a fixed number of shares or contracts traded, similar to the interval clause 604. The interval clause may also include a range-interval clause. In some embodiments, the range-interval clause defines a bar interval based at least in part on a fixed dollar range, a fixed point range, or a fixed tick range.

In some embodiments, the timeframe phrase 402-B includes an interval clause and the query-input string does not specify an interval clause for the timeframe phrase 402-B. Completing the phrases in the plurality of phrases of the query structure comprises setting the interval clause 604 of the timeframe phrase 402-B equal to a default time interval. In such an embodiment, the default time interval is daily.

FIG. 6B depicts variations of the market phrase, in accordance with an embodiment. In particular, FIG. 6B depicts the variations 650. The variations 650 includes the market phrase 402-C, an [A-Z] segment 652-A, an [A-Z] segment 652-B, the [0-9] segment 614, a “stock” segment 654, a “continuous” segment 656, and a “by contract” segment 658.

In one embodiment of generating the market phrase 402-C portion of the query structure, the market phrase 402-C includes a symbol definition clause. The first portion of symbol definition clause includes the first [A-Z] segment 652-A and is followed by any combination of segments from the [A-Z] segment 652-B and the [0-9] segment 614. The [A-Z] segments 652-A and 652-B can be any alphabet letter. The first portion of the symbol definition clause may be a stock identifier. A final portion of the symbol definition clause is selected from the “stock” segment 654, the “continuous” segment 656, and the “by contract” segment 658. Other variations of the symbol-definition clause include a continuous-back-adjusted-prices keyword and a futures identifier, a prices-by-contract keyword and a futures identifier.

The market phrase may also include a spread-definition clause. The spread-definition clause is used to retrieve information about spreads. The retrieved information may be retrieved with the symbol, the month and year. A “continuous” segment may be added as an identifier to roll the data forward to evolve the front and back month contracts to determine spread price automatically.

The market phrase may also include a user-defined-basket keyword and a basket identifier. The user-defined basket is a basket of instruments for use in retrieving cross-sectional information. Some examples of baskets include all stocks in a stock exchange, such as the S&P 500, all stocks in a user's portfolio, and the like. The user-defined-basket keyword is a keyword indicating the name of the basket. For example, the user-defined-basket keyword for all stocks in the S&P 500 may be “spx”, and the user-defined-basket keyword for all stocks in a portfolio may be “mystocks”.

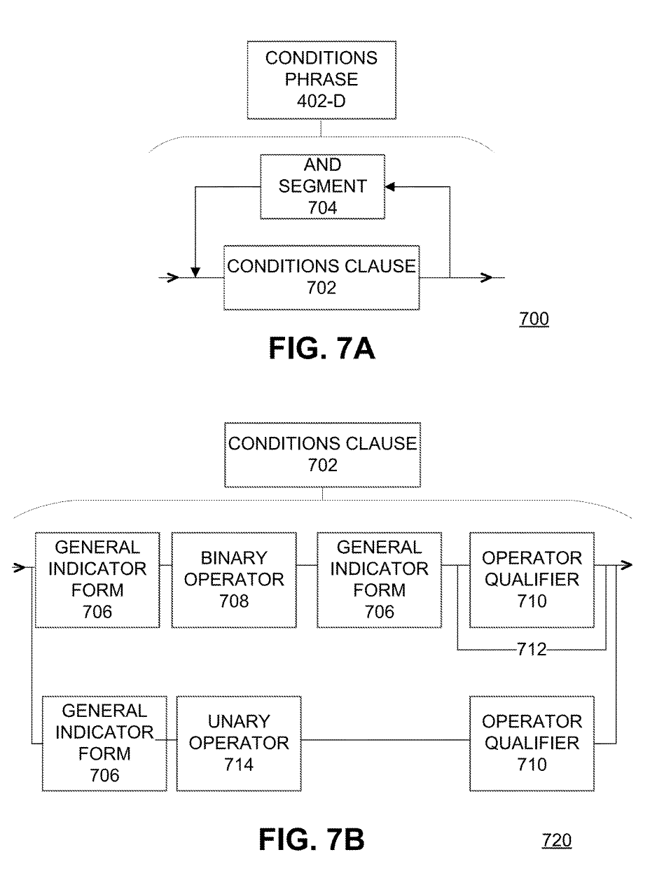

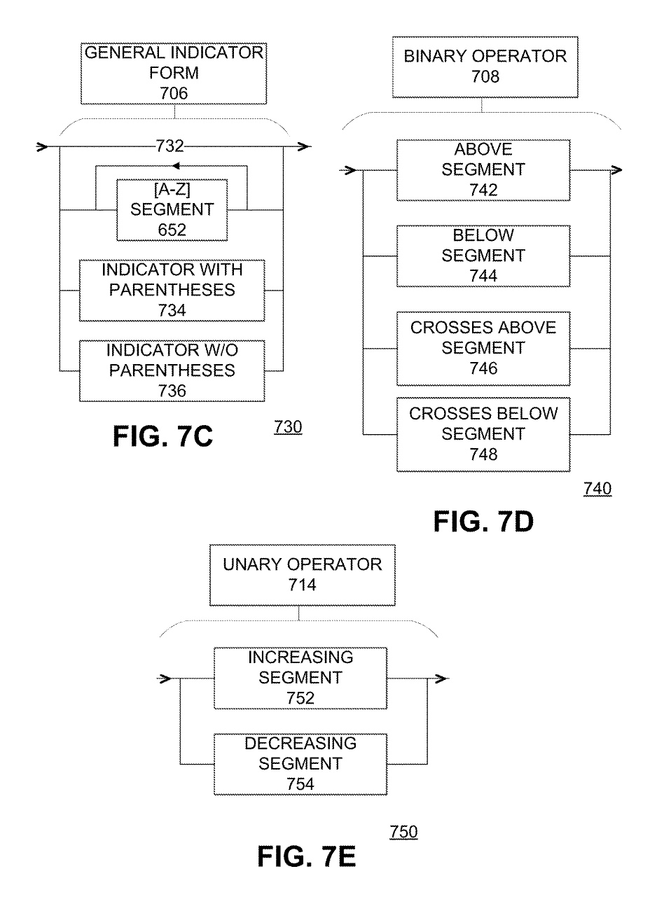

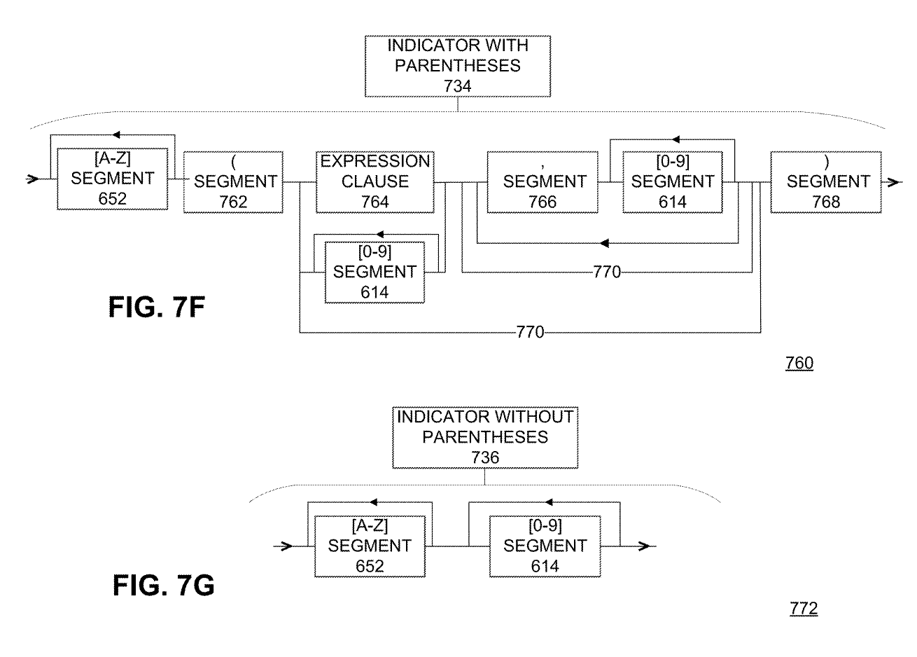

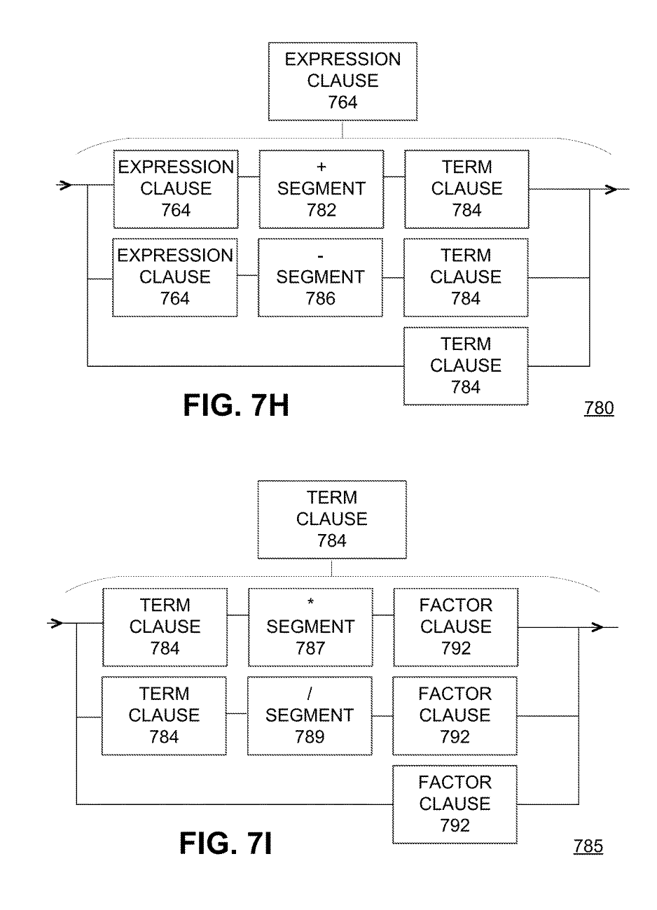

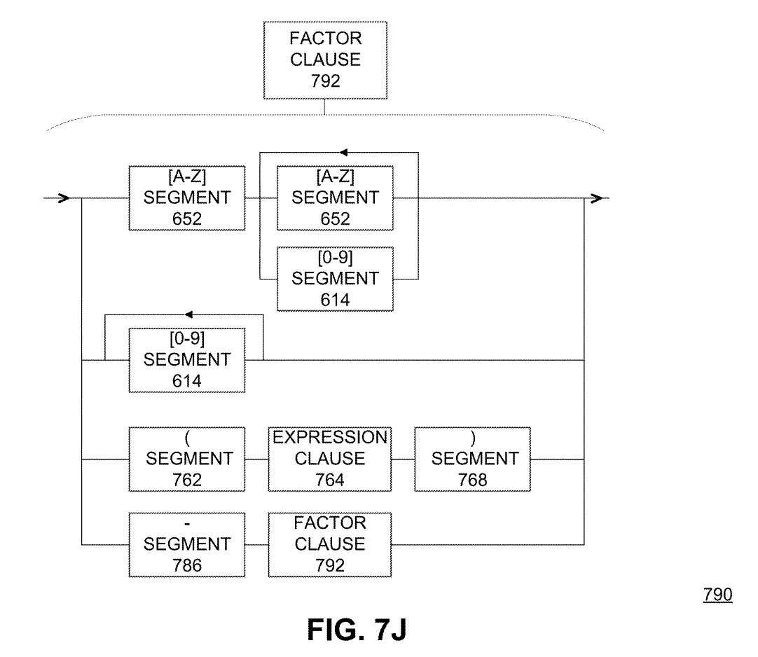

FIG. 7A depicts variations of the conditions phrase, in accordance with an embodiment. In particular, FIG. 7A depicts the variations 700 of the conditions phrase 402-D. The variations 700 include the conditions phrase 402-D, a conditions clause 702, and an “and” segment 704. As shown in FIG. 7A, the conditions phrase 402-D may include a single conditions clause 702, or multiple conditions clauses, each separated by the “and” segment 704.

FIG. 7B depicts variations of the conditions clause, in accordance with an embodiment. In particular, FIG. 7B depicts the variations 720. The variations 720 includes the conditions clause 702, general indicator forms 705, binary operator 708, operator qualifiers 710, a null segment 712, and a unary operator 714. As shown in FIG. 7B, the conditions clause 702 may go from left to right along either the top or bottom path of the variations 720. In the top path, the conditions clause 702 includes first the general indicator form 706, then a binary operator 708, then a second general indicator form 706, and either the operator qualifier 710 or the null segment 712. In the bottom path, the conditions clause 702 includes first the general indicator form 706, then the unary operator 714, and then the operator qualifier 710.

FIG. 7C depicts variations of the general indicator form, in accordance with an embodiment. In particular, FIG. 7C depicts the variations 730. The variations 730 includes the general indicator form 706, a null segment 732, an [A-Z] segment 752, an indicator with parentheses 734, and an indicator without parentheses 736.

The general indicator form 706 may take the form of any of the variations depicted in FIG. 7C, to include the null segment 732, any number of [A-Z] segments 652, the indicator with parentheses 734, or the indicator without parentheses 736. The null segment 732 is similar to other null segments discussed herein.

FIG. 7D depicts variations of the binary operator, in accordance with an embodiment. In particular, FIG. 7D depicts the variations 740. The variations 740 includes the binary operator 708, an “above” segment 742, a “below” segment 744, a “crosses above” segment 746, and a “crosses below” segment 748.

The binary operator 708 may take the form of any of the variations depicted in FIG. 7D, to include the “above” segment 742, the “below” segment 744, the “crosses above” segment 746, and the “crosses below” segment 748.

FIG. 7E depicts variations of the unary operator, in accordance with an embodiment. In particular, FIG. 7E depicts the variations 750. The variations 750 includes the unary operator 714, an “increasing” segment 752, and a “decreasing” segment 754.

The unary operator 714 may take the form of any of the variations depicted in FIG. 7E, to include the “increasing” segment 752 or the “decreasing” segment 754.

FIG. 7F depicts variations of the indicator with parentheses, in accordance with an embodiment. In particular, FIG. 7F depicts the variations 760. The variations 760 include the [A-Z] segment 652, a “(” (open parentheses) segment 762, an expressions clause 764, [0-9] segments 614, a “,” (comma) segment 766, and a “)” (closed parentheses) segment 768, and null segments 770.

The indicator with parentheses 734 may take the form of any of the variations depicted in FIG. 7F. Similar to the other variations discussed herein, the indicator with parentheses 734 starts with any number of [A-Z] segments 652 followed by the “(” (open parentheses) segment 762. Next, the indicator with parentheses 734 may include either an expression clause 764, any number of [0-9] segments 614, or a null segment 770. After either the expression clause 764 or the segment 614, the indicator with parentheses 734 further includes either a null segment 770 or a “,” (comma) segments 766 followed by any number of [0-9] segments 614, which may be repeated. Lastly, the indicator with parentheses 734 includes a “)” (closed parentheses) segment 768.

FIG. 7G depicts variations of the indicator without parentheses, in accordance with an embodiment. In particular, FIG. 7G depicts the variations 772. The variations 772 include the indicator without parentheses 736, the [A-Z] segment 652, and the [0-9] segment 614. In forming the indicator without parentheses 736, first any number of [A-Z] segments 652 are listed followed by any number of [0-9] segments 614.

FIG. 7H depicts variations of the expression clause 764, in accordance with an embodiment. In particular, FIG. 7H depicts the variations 780. The variations 780 includes expression clauses 764, a “+” segment 782, term clauses 784, and a “−” segment 786.

The expression clause 764 may take the form of any of the variations depicted in FIG. 7H. For example, the expression clause may 764 may take the form along the top row with a nested express clause 764, next a “+” segment 782, and followed by the term clause 784. As shown along the middle row, the expression clause 764 may be the nested expression clause 764, next a “−” segment 786, and followed by the term clause 784. As shown along the bottom row, the expression clause 764 may take the form of just a term clause 784.

FIG. 7I depicts variations of the term clause 784, in accordance with an embodiment. In particular, FIG. 7I depicts the variations 785. The variations 785 includes term clauses 784, a “*” segment 787, “/” segment 789, and factor clauses 792. Similar to the expression clause depicted in FIG. 7H, the term clause may go along either the top, middle, or bottom row.

FIG. 7J depicts variations of the factor clause 792, in accordance with an embodiment. In particular, FIG. 7J depicts the variations 790. The variations 790 includes the factor clause 792, [A-Z] segments 652, [0-9] segments 214, the “(“segment 762, the expression clause 764, the”)” segment 768, the “-” segment 786, and the factor clause 792.

The factor clause 792 may take the form of any of the variations depicted in FIG. 7J, to include going along any one of the four depicted paths. In the top path, the factor clause 792 includes a symbol definition clause comprising a first [A-Z] segment 652, followed by any number of [A-Z] segments 652 and [0-9] segments 614. In the second from the top path, the factor clause 792 includes any number of [0-9] segments 614. In the third from the top path, the factor clause 792 includes the “(” segment 762, the expression clause 764, and the “)” clause 768. In the fourth from top path, the factor clause 792 includes the “−” segment 786 and the factor clause 792.

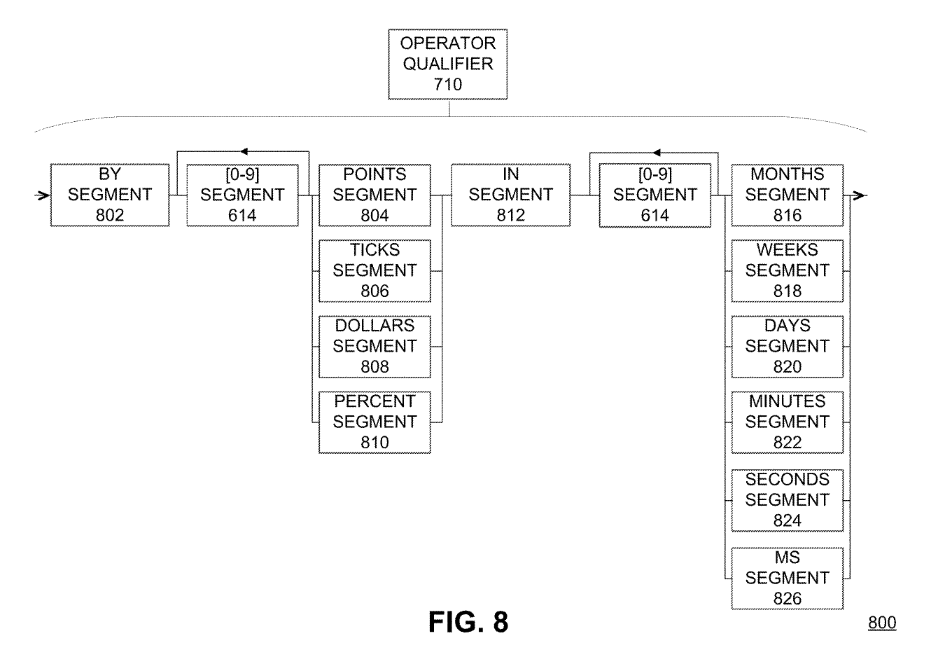

FIG. 8 depicts variations of an operator qualifier, in accordance with an embodiment. In particular, FIG. 8 depicts the variations 800. The variations 800 includes the operator qualifier 710, a “by” segment 802, [0-9] segments 614, a “points” segment 804, a “ticks” segment 806, a “dollars” segment 808, a “percent” segment 810, and “in” segment 812, a “months” segment 816, a “weeks” segment 818, a “days” segment 820, a “minutes” segment 822, a “seconds” segment 824, and an “ms” segment 826.

The operator qualifier 710 may take any of the forms depicted in the FIG. 8. For example, the operator qualifier 710 starts with the “by” segment 802, followed by any number of [0-9] segments 614, a selection of one of the “points”, “ticks, “dollars”, or “percent” segments 804-810, followed by the “in” segment 812, any number of [0-9] segments 614, and a selection of one of the “months”, “weeks”, “days”, “minutes”, “seconds”, or “ms” segments 816-826.

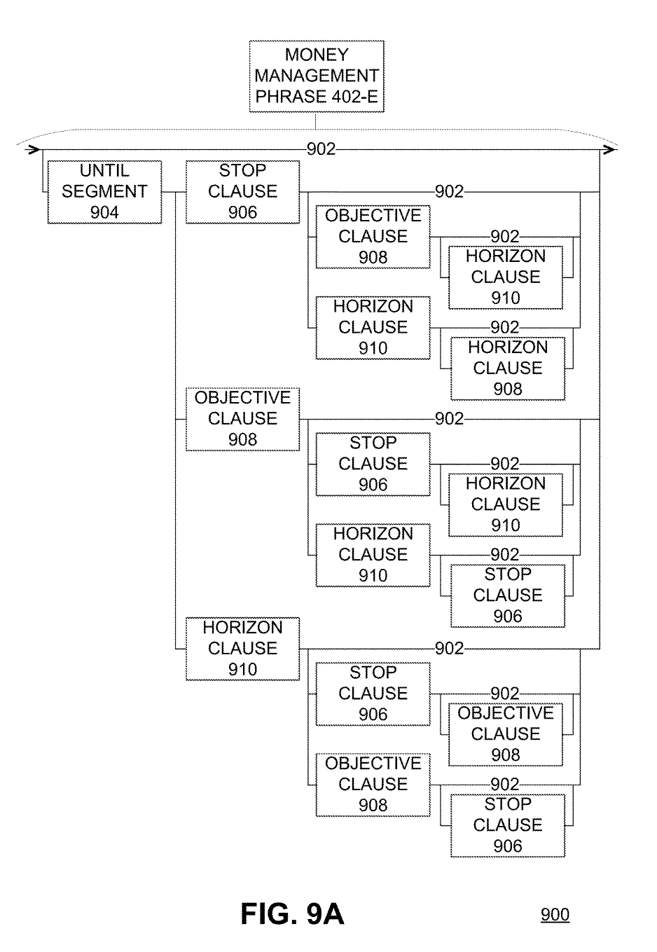

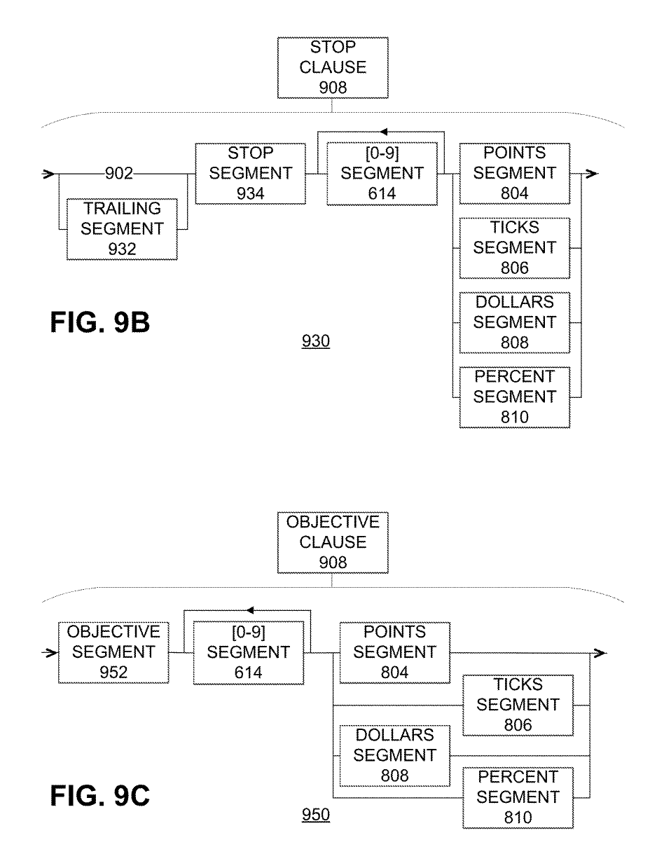

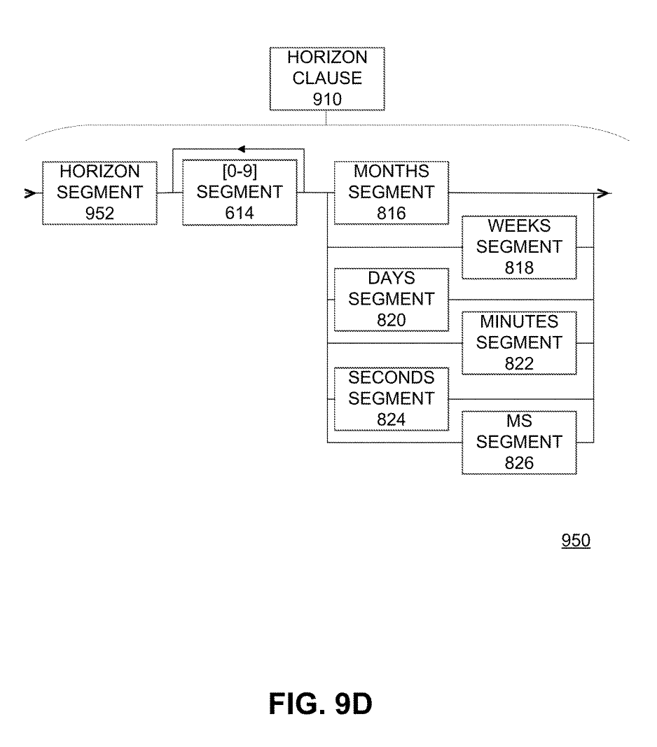

FIG. 9A depicts variations of the money management phrase, in accordance with an embodiment. In particular, FIG. 9A depicts the variations 900. The variations 900 includes the money management phrase 402-E, null segments 902, an “until” segment 904, stop clauses 906, objective clauses 908, and horizon clauses 910.

The money management phrase 402-E may take the form of any of the variations depicted in FIG. 9A, to include a money management clause that includes just the null segment 902, or the “until” segment 904 followed by any combination of stop clauses 906, objective clauses 908, or horizon clauses 910. The money management phrase 402-E may comprise one or more money-management clauses or consist of one or more money-management clauses.

FIG. 9B depicts variations of the stop clause, in accordance with an embodiment. In particular, FIG. 9B depicts the variations 930. The variations 930 includes the stop clause 908, the null segment 902, a “trailing” segment 932, a “stop” segment 934, the [0-9] segment 614, the “points” segment 804, the “ticks” segment 806, the “dollars” segment 808, and the “percent” segment 810.

The stop clause 908 may take the form of any of the variations depicted in FIG. 9B, to include either the null segment 902 or the “trailing” segment 932 followed by the “stop” segment 934, any number of [0-9] segments 614, followed by a selection of units. The selection of units may for example be the “points”, “ticks”, “dollars”, or “percent” segments 804-810.

FIG. 9C depicts variations of the objective clause, in accordance with an embodiment. In particular, FIG. 9C depicts the variations 950. The variations 950 includes the objective clause 908, an “objective” segment 952, the [0-9] segment 614, the “points” segment 804, the “ticks” segment 806, the “dollars” segment 808, and the “percent” segment 810.

The objective clause 908 may take the form of any of the variations depicted in FIG. 9C, to include the “objective” segment followed by any number of [0-9] segments 614 followed by a selection of units. The selection of units may for example be the “points”, “ticks”, “dollars”, or “percent” segments 804-810.

FIG. 9D depicts variations of the horizon clause, in accordance with an embodiment. In particular, FIG. 9D depicts the variations 950. The variations 950 includes the horizon clause 910, a “horizon” segment 952, the [0-9] segments 614, the “months” segment 816, the “weeks” segment 818, the “days” segment 820, the “minutes” segment 822, the “seconds” segment 824, and the “ms” segment 826.

The horizon clause 910 may take the form of any of the variations depicted in FIG. 9D to include the “horizon” segment 952, followed by any number of [0-9] segments 614, followed by a selection of time units. The selection of time units may be the “months”, “weeks”, “days”, “minutes”, “seconds”, or “ms” segments 816-826. Additional variations of the horizon clause 910 include measuring the horizon in units other than time, such as a number of bars, trades, shares, and the like.

In one embodiment, the money-management phrase consists of a money-management clause. In such an embodiment, the query-input string does not specify a money-management clause for the money-management phrase, and completing the phrases in the plurality of phrases of the query structure comprises adding a default money-management clause to the money-management phrase. On example default money-management clause is a one-bar horizon money-management clause. Using the variations depicted in FIGS. 9A and 9C, the one-bar horizon money-management clause may include: the “until” segment 904, followed by the third path from the top with the horizon clause 910 and the null segment 902. The horizon clause 910 would include the “horizon” segment 952, a “1” from the [0-9] segment 614, and a “bar” segment, in lieu of one of the time units segments 816-826 depicted in FIG. 9D. When pieced together, the one-bar horizon money-management clause would include the following: “until horizon 1 bar”.

In one embodiment, the timeframe phrase comprises an interval clause and a time-box clause, the market phrase comprises a symbol-definition clause, and the conditions phrase comprises a price clause. In such an embodiment, the timeframe phrase 402-B includes both the time-box clause 602 and the interval clause 604; the market phrase 402-D includes the symbol definition clause that includes a first [A-Z] segment 652-A and any number of [A-Z] segments 652-B and [0-9] segments 614; the conditions phrase 402-D includes segments defining the price. In an alternative embodiment, the timeframe phrase consists of an interval clause and a time-box clause; the market phrase consists of a symbol-definition clause; and the conditions phrase consists of a price clause.

In accordance with an embodiment, the conditions phrase comprises: one or both of an event clause and a state clause; comprises an event clause or a state clause; consists of an event clause or a state clause; consists of an event clause; or consists of a state clause.

As an example of a state clause or an event clause, the conditions phrase 402-D may include the conditions clause 702 that includes the binary operator 708 or the unary operator 714. The conditions phrase 402-D may further relate a price to an indicator, such as a moving average of the price. The conditions phrase 402-D may relate a first indicator to a second indicator, such as relating an exponential moving average of a price over a first time period to an exponential moving average of the price over a second time period. One such example of query-input string for querying a time-series database is phrased as: “What happens when the 20 day ema (exponential moving average) is above the 50 day ema (exponential moving average)?”

In accordance with an embodiment, the conditions phrase 402-D specifies a crossing event. Such a crossing event may pertain to a price and an indicator related to the price or pertain to two different indicators related to a price. One such crossing event queries for when a price changes from one state to another state relative to an indicator. In crossing events, the query result set depends on one price input data source.

In accordance with an embodiment, an event clause may be associated with a news-release event. A news-release event retrieve data from a price input data source and a news input data source in order to generate the query result set. One such example for querying a time-series database with a news-release event is phrased as: “What happens to es (symbol for E-Series futures) on days when cpi (consumer price index) release comes out above expected value by 0.3?” A query structure generated based on such a query-input string may be: “es continuous and cpi release above expected by 0.3”.

In one embodiment, the buy-sell phrase 402-A consists of the trade clause 502, the timeframe phrase 402-B consists of the time-box clause 602 and the interval clause 604, the market phrase 402-C consists of a symbol definition clause, the conditions phrase 402-D consists of one or both of (i) a price clause and (ii) one or both of an event clause and a state clause; and the money-management phrase 402-E consists of one or more money-management clauses.

In accordance with an embodiment, the query-input string specifies one of a state query, an event query, and a strategy query. In such an embodiment, the query-input string specifies a state query; the query-input string specifies an event query, and the query-input string specifies a strategy query.

A state query retrieves data about the time series when a price is in a particular state relative to an indicator. One example query-input string may be: “What happens to the price of the S&P 500 E-mini futures contract the day after it closes above its 20 day ema in 2012?” Portions of the example query-input string may be used to generate the query structure. For example, the query structure may include a symbol definition clause of “es” indicating the S&P 500 E-mini futures contracts followed by a “continuous” segment, and a state clause that includes the “above” segment and the “ema 20” indicating the 20 day exponential moving average. Thus, the example query structure includes: “es continuous above ema 20”.

Additional segments may be added to the query structure. These additional segments may be default values, and may be supplemented into the query structure. For example, the buy-sell phrase 402-A is a “buy” segment 508, the time-frame phrase 402-B includes the interval clause 604 that includes the “daily” segment 618 and a time-box clause 602 that includes the start and stop segments 610-612 as “date 20120101 to 20121231”. The market phrase 402-C further includes in the symbol definition clause letter indicators for months “FGHJKLMNOYXZ” and a contract identifier of “depth 0”, and a “close” segment indicating closing prices are to be retrieved. The money-management phrase 402-E may include the “until” segment 904 followed by a horizon clause 910 that includes the horizon segment 952, a “1” from the [0-9] segment 614, and a “day” segment 820. Thus, the example query structure, with added segments, includes: “buy daily es continuous FGHJKLMNOYXZ depth 0 date 20120101 to 20121231 close above ema 20 until horizon 1 day”.

Such an example query structure, when submitted to a query-processing system for use in querying the time-series database, results in a query result set that was obtained from the time-series database. The input data source are daily prices for the S&P 500 E-mini futures contract (es) beginning Jan. 1, 2012 and ending Dec. 31, 2012. The result set includes data from when the close price for the front month contract was above its 20 day ema until the horizon, which is 1 day. To generate the result set, a simulated long (buy) round trip trades are evaluated using the close price. At the close of each day, if the state is true (i.e. if the close is above the 20 day ema), then a simulated long position is opened at the close price. Even though the price used to evaluate the state could be an alternate price, for example the high price, the close price is used to open positions. With a 1 day horizon, the position is closed at the close price. The position opening price and closing price are used to calculate the change in price. An implied size may be used for each trade, for example one contract or share.

In some embodiments, the query-input string specifies a strategy query. A strategy query is an extension of a state or event query that back tests trading strategies using both long and short simulated positions. For example, a strategy query asks what happens to a strategy that buys when a ‘crosses above’ event occurs and sells when a ‘crosses below’ event occurs. This strategy query includes the ‘inverse’ keyword. For events related to financial moving averages, a “buy and inverse sell” clause means that a long position is opened on the occurrence of the moving average crossing above an event, such as the 20 day moving average, and inversely, a short position is opened on the occurrence of the moving average crossing below the event. With respect to inverse conditions for indicators, the opposite logic applies. For example, a query opens long positions when the 14 day relative strength index (rsi) crosses above 80, a short position is opened when the 14 day rsi crosses below 20.

In some embodiments, parsing the query-input string comprises treating at least one specified segment as being synonymous with at least one unspecified segment. Examples of synonymous segments may be found in Tables 1-3. Table 1 depicts various synonymous segments for use in parsing the query-input string. Table 2 depicts various synonymous segments for use in parsing the query-input string relating to indicator segments. Table 3 depicts various synonymous segments for use in parsing the query-input string relating to events. For example, the query-input string may include a sequence of delimited character strings indicating an average directional movement index indicator. Referring to Table 1, parsing this portion of the query-input string may include treating the segment “adx” as synonymous with the “average directional movement index” segment.

TABLE 1
Synonymous Segments

| | |
|---|---|
| buy | Buy orders to open position |
| pyramid | Position builder specifier |
| rolling | Same as pyramid |
| sell | Sell order to close position |
| inverse | Opposite of position entry logic, dependent on indicator |
| | type |
| daily | Fixed daily time interval |
| minute(s) | Fixed minute-based time interval (e.g. 5 minutes) |
| contract(s) | Fixed number of contracts traded (per bar) interval |
| share(s) | Fixed number of shares traded (per bar) interval |
| trade(s) | Fixed number of executions (per bar) interval |
| dollar(s) | Fixed dollar range (per bar) interval |
| point(s) | Fixed point range (per bar) interval |
| tick(s) | Fixed tick range (per bar) interval |
| stock | Stock identifier, using split and dividend back-adjusted |
| | prices |
| by contract | Futures identifier, using prices by contract |
| continuous | Futures identifier, using continuous back-adjusted prices |
| basket | User-defined basket (of stocks or futures) identifier |
| depth | Contract depth (Related to futures, may default to 0, |
| | meaning front month |
| d2r | Days to roll (Related to futures) |
| F, G, H, J, K, M, | Month Codes for January, February, March, April, May, |
| N, Q, U, V, X, Z | June, July, August, September, October, November, |
| | December |
| crosses | Value changes states relative to the value of an |
| | indicator |
| news | News release events, (See Table 3) |
| release | Same as news |
| above | The value is above that of some threshold or indicator |
| below | The value is below that of some threshold or indicator |
| decreasing | The value is going down some amount over some |
| | interval |
| contracting | Same as decreasing |
| drop(s) | Same as decreasing |
| increasing | The value is going up some amount over some interval |
| expanding | Same as increasing |
| rally(ies) | Same as increasing |
| bottom | Used to rank symbols based on some condition |
| top | Used to rank symbols based on some condition |
| dollar(s) | Dollars |
| percent | Percentage points |
| point(s) | Price points |
| tick(s) | Number of ticks |
| open | Opening price of the bar |
| high | High price of the bar |
| low | Low price of the bar |
| close | Closing price of the bar |
| bar(s) | Number of intervals |
| day(s) | Calendar days |
| yesterday | Previous day |
| year(s) | Year, format may be (YYYY, YY, or the like) |
| month(s) | Calendar month (MM) |
| week(s) | Calendar week |
| dayofweek | Monday (1), Tuesday (2), Wednesday (3), Thursday (4), |
| | Friday (5) |
| timeofday | Time using gmt (Greenwich mean time) (HHMMSS) |
| until | Introduces an explicit position exit clause |
| horizon | Specifies a time for when to exit the position |
| obj | Specifies a unit goal for when to exit the position |
| stop | Specifies a stop loss for when to exit the position |
| target | Same as obj |
| trailing | Indicated the stop is a trailing stop |
| between | Specifies a range of values for comparision |
| from | Introduction of timebox clause |
| in | Used in timebox clause |
| to | Used to specify end date of timebox claus |
| with | used in timebox clause |
| and | Joins data in a query |
| as | Used to create an alias |
| like | Use similarity test (For example: dtw for dynamic time |
| | warping, or euc for Euclidean distance. Other |
| | dimension reduction algorithms could be defined) |
| # | Comment specifier |
| self | Specifies use of the indicator of the indicator |
| similar | Number of historical instances to return (used with |
| | like) |
| + | Plus |
| − | Minus |
| * | Multiply |
| / | Divide |
| > | Greater than |
| < | Less Than |
| = | Equals |
| >= | Greater than and equal to |
| <= | Less than and equal to |

TABLE 2
Synonymous Segments Related to Indicators

| | |
|---|---|
| actual | For news releases, the value released |
| adosc | Chaikin AD oscillator |
| adx | Average directional movement index |
| apo | Absolute price oscillator |
| aroonosc | Aroon oscillator |
| atr | Average true range |
| closedrop | High price minus closing price |
| close jump | Closing price minus low price |
| dema | Double exponential moving average |
| ema | Exponential moving average |
| fib | Fibonacci levels |
| gap | Opening gap |
| kama | Kaufman adaptive moving average |
| linreg | Linear regression |
| lr-slope | Linear regression slope |
| ma | Moving average |
| macd | Moving average convergence divergence |
| maxindex | Index of maximum |
| mfi | Money flow index |
| mid | Midpoint |
| midprice | Midpoint price |
| minindex | Index of minimum |
| moa | Monthly seasonality |
| mom | Momentum (price change) |
| natr | Normalized average true range |
| nr | Narrow range |
| oi | Open interest |
| opendrop | Open price minus low price |
| openjump | High price minus open price |
| ppo | Percentage price oscillator |
| range | Trading range (high-low) |
| ret | Return |
| rocr | Rate of change ratio |
| rsi | Relative strength indicator |
| sfd | Stochastic fast D indicator |
| sfk | Stochastic fast K indicator |
| ssd | Stochastic slow D indicator |
| ssk | Stochastic slow k indicator |
| std | Standard deviation |
| t3 | Triple exponential moving average |
| trix | Rate of change of triple smooth ema |
| tsf | Time series forecast |
| ultosc | Ultimate oscillator |
| volume | Trading volume |
| wa | Weekly seasonality |
| willr | William's % r indicator |
| ya | Yearly seasonality |

TABLE 3
Synonymous Segments Related to Events

| | |
|---|---|
| ccs | Consumer confidence survey |
| cci | Same as ccs |
| cs | Crude oil stocks |
| csi | Consumer sentiment index |
| umi | Same as csi |
| ehs | Existing home sales |
| gdp | Real gross domestic product |
| ngs | Natural gas stocks |
| ipi | Industrial production |
| jc | Jobless claims (initial claims) |
| mis | Manufacturing inventory sales |
| nfp | Non-farm payroll |
| nhs | New home sales |
| nrs | Housing starts (new residential construction) |
| pf/bos | Philly Fed business outlook survey |
| ppi | Producer price index |
| rs | Retail sales |
| tis | Trade inventory and sales |
| ur | Unemployment rate |
| eps | Stock earnings release |
| upgrades | Analysts changing recommendations |
| downgrades | Analysts changing recommendations |
| guidance | Opinion of corporate insider |
| revenue | Stock revenue release |
| margins | Gross margins release |
| consensus | Analysts' consensus estimate |
| expected | Same as consensus |

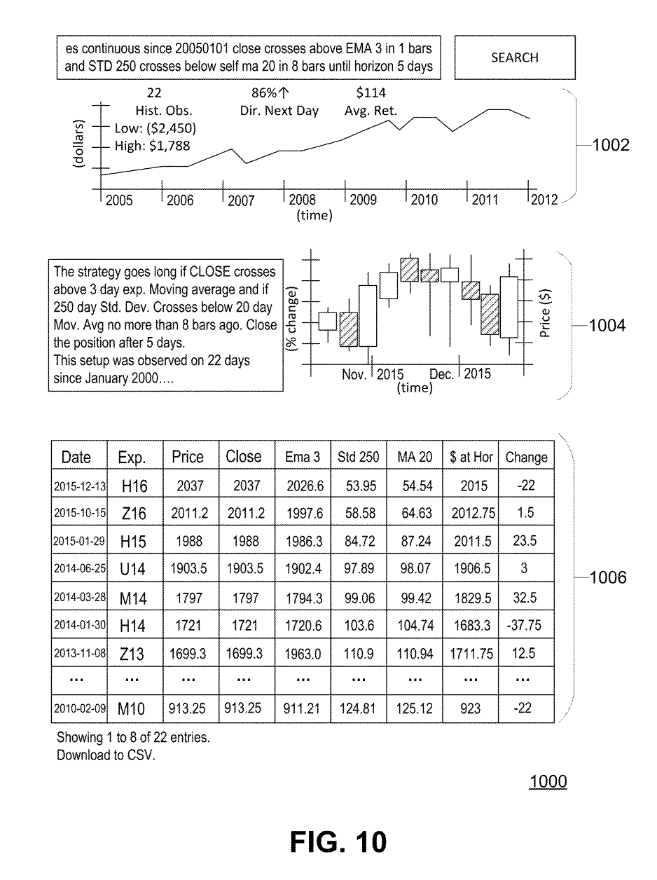

FIG. 10 depicts a presentation of a query-response set, in accordance with an embodiment. In particular, FIG. 10 depicts the presentation 1000. The presentation 1000 includes an equity curve 1002, a graphical depiction of the query result set 1004, and a table of data from the query result set 1006.

The presentation 1000 represents outputting the received query result set presentation via the user interface. The user interface may be a screen on smart-phone, computer monitor, laptop, or the like.

In some embodiments, the time-series database comprises database records that includes at least one of the following records: a respective database-record timestamp corresponding to a beginning of a respective database-record time interval; a respective database-record opening price for the respective database-record time interval; a respective database-record closing price for the respective database-record time interval; a respective database-record high price during the respective database-record time interval; a respective database-record low price during the respective database-record time interval; a respective database-record transaction volume during the respective database-record time interval; a respective database-record open-interest-at-close value for the respective database-record time interval, and a respective database-record contact-expiration date for the respective database-record time interval.

Further, the query result set may further comprise records related to the above database records. For example, a presentation of the query result set may by output per the table of data 1006 of FIG. 10.

In accordance with an embodiment, the method further comprises calculating at least one statistic based on the query result set and outputting the at least one calculated statistic for presentation via the user interface. Example statistics include average return, standard deviation of returns, range of changes, maximum drawdown, and the like.

In accordance with an embodiment, the method further includes calculating at least one ratio based on the query result set and outputting the at least one calculated ratio for presentation via the user interface. Example ratios include one or more of a Sharpe ratio, an information ratio, and a capability performance ratio.

In accordance with an embodiment, the method further includes calculating at least one equity curve based on the query result set and outputting the at least one calculated equity curve for presentation via the user interface.

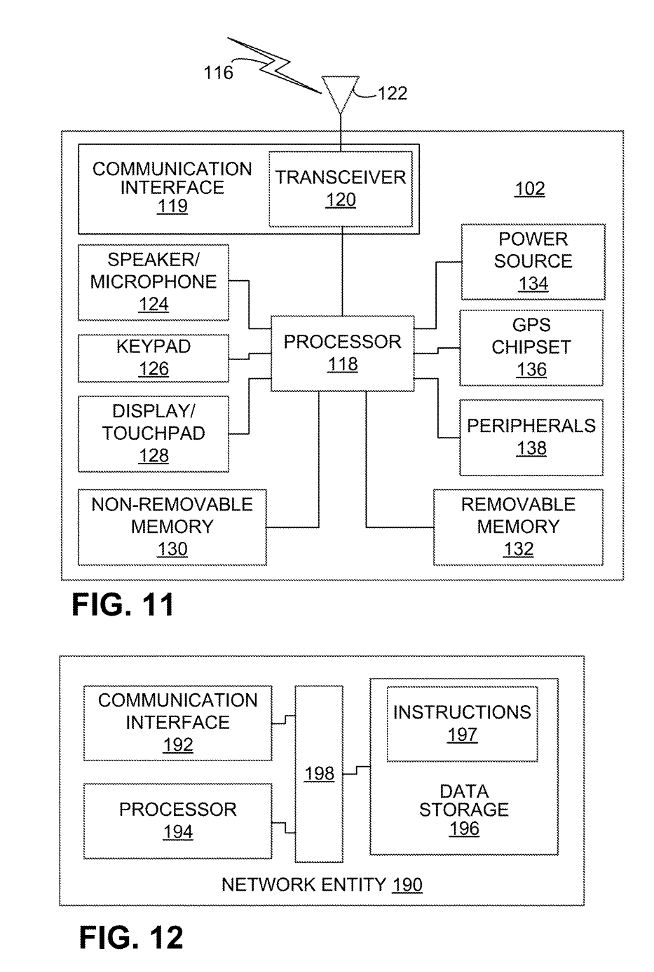

FIG. 11 illustrates an exemplary wireless transmit/receive unit (WTRU), in accordance with an embodiment. The WTRU may serve as a device capable of receiving a query-input string, generating a query structure, submitting the g\query structure to a query-processing system, receiving the query result set, and outputting the received query result set. As shown in FIG. 11, the WTRU 102 may include a processor 118, a communication interface 119 including a transceiver 120, a transmit/receive element 122, a speaker/microphone 124, a keypad 126, a display/touchpad 128, a non-removable memory 130, a removable memory 132, a power source 134, a global positioning system (GPS) chipset 136, and sensors 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 11 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, as examples. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 11 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, as examples.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include sensors such as an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 12 illustrates an exemplary network entity, in accordance with an embodiment. The exemplary network entity 190 that may be used in embodiments of the present disclosure, for example as a device receiving a query structure, a query-processing system, and the like. As depicted in FIG. 12, network entity 190 includes a communication interface 192, a processor 194, and non-transitory data storage 196, all of which are communicatively linked by a bus, network, or other communication path 198.

Communication interface 192 may include one or more wired communication interfaces and/or one or more wireless-communication interfaces. With respect to wired communication, communication interface 192 may include one or more interfaces such as Ethernet interfaces, as an example. With respect to wireless communication, communication interface 192 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 192 may be equipped at a scale and with a configuration appropriate for acting on the network side—as opposed to the client side—of wireless communications (e.g., LTE communications, Wi-Fi communications, and the like). Thus, communication interface 192 may include the appropriate equipment and circuitry (perhaps including multiple transceivers) for serving multiple mobile stations, UEs, or other access terminals in a coverage area.

Processor 194 may include one or more processors of any type deemed suitable by those of skill in the relevant art, some examples including a general-purpose microprocessor and a dedicated DSP.

Data storage 196 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 12, data storage 196 contains program instructions 197 executable by processor 194 for carrying out various combinations of the various network-entity functions described herein.

Various different embodiments can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM, a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a ROM, a RAM, a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

It will be appreciated that some embodiments may be comprised of one or more generic or specialized processors (or “processing devices”) such as microprocessors, digital signal processors, customized processors and FPGAs and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more ASICs, in which each function or some combinations of certain of the functions are implemented as custom logic. Of course, a combination of the two approaches could be used.

We claim:

1. A method comprising:
receiving a query-input string for querying a time-series database, wherein the query-input string comprises a sequence of delimited character strings;
generating a query structure based on the query-input string, wherein:
the query structure comprises a plurality of phrases that each comprise one or more clauses that each comprise one or more segments;
the character strings specify one or more of the segments of one or more of the clauses of one or more of the phrases; and
generating the query structure based on the query-input string comprises:
parsing the query-input string to identify the one or more specified segments; and
adding the one or more specified segments to the corresponding one or more phrases of the query structure;
submitting the query structure to a query-processing system for use in querying the time-series database;
receiving a query result set that was obtained from the time-series database as being responsive to the submitted query structure; and
outputting the received query result set for presentation via a user interface.

2. The method of claim 1, wherein receiving the query-input string comprises receiving the query-input string via the user interface.

3. The method of claim 1, wherein receiving the query-input string comprises receiving the query-input string via a network connection.

4. The method of claim 1, wherein the time-series database comprises a financial-information time-series database.

5. The method of claim 1, wherein delimited comprises whitespace-delimited.

6. The method of claim 1, wherein generating the query structure based on the query-input string further comprises completing the phrases in the plurality of phrases of the query structure using one or both of at least one predetermined default segment and at least one predetermined default clause.

7. The method of claim 1, wherein the plurality of phrases comprises a buy-sell phrase, a timeframe phrase, a market phrase, a conditions phrase, and a money-management phrase.

8. The method of claim 7, wherein the plurality of phrases consists of the following phrases in the following order: buy-sell phrase, the timeframe phrase, the market phrase, the conditions phrase, and the money-management phrase.

9. The method of claim 8, wherein generating the query structure based on the query-input string further comprises completing the phrases in the plurality of phrases of the query structure using one or both of at least one predetermined default segment and at least one predetermined default clause.

10. The method of claim 1, wherein the query-input string specifies one of a state query, an event query, and a strategy query.

11. The method of claim 1, wherein parsing the query-input string comprises parsing the query-input string in a case-insensitive manner.

12. The method of claim 1, wherein parsing the query-input string comprises treating at least one specified segment as being synonymous with at least one unspecified segment.

13. The method of claim 1, wherein receiving the query result set comprises receiving the query result set from the query-processing system.

14. The method of claim 1, wherein receiving the query result set comprises receiving the query result set from the time-series database, the method further comprising:
transmitting, to the query-processing system, routing instructions for use by the time-series database in returning the query result set.

15. The method of claim 1, wherein the query result set comprises one or more pointers to corresponding original data in the time-series database, the method further comprising:
using at least one pointer from the query result set to extract additional information from the time-series database.

16. The method of claim 1, further comprising:
presenting the received query-response set via the user interface.

17. The method of claim 1, further comprising:
calculating at least one statistic based on the query result set; and
outputting the at least one calculated statistic for presentation via the user interface.

18. The method of claim 1, further comprising:
calculating at least one ratio based on the query result set; and
outputting the at least one calculated ratio for presentation via the user interface.

19. The method of claim 1, further comprising:
calculating at least one equity curve based on the query result set; and
outputting the at least one calculated equity curve for presentation via the user interface.

20. A system comprising:
a user interface;
a communication interface;
a processor; and
data storage containing instructions executable by the processor for causing the system to carry out a set of functions, the set of functions including:
receiving a query-input string for querying a time-series database, wherein the query-input string comprises a sequence of delimited character strings;
generating a query structure based on the query-input string, wherein:
the query structure comprises a plurality of phrases that each comprise one or more clauses that each comprise one or more segments;
the character strings specify one or more of the segments of one or more of the clauses of one or more of the phrases; and
generating the query structure based on the query-input string comprises:
parsing the query-input string to identify the one or more specified segments; and
adding the one or more specified segments to the corresponding one or more phrases of the query structure;
submitting the query structure to a query-processing system for use in querying the time-series database;
receiving a query result set that was obtained from the time-series database as being responsive to the submitted query structure; and
outputting the received query result set for presentation via the user interface.
